(19) United States
(12) Patent Application Publication
(10) Pub. No.: US 2001/0034974 A1
(43) Pub. Date: Nov. 1, 2001

(54) Portable modular plant growing system

(76) Inventors: Brenda C. Cameron, Boise, ID (US); Brian A. Cameron, Boise, ID (US)

Correspondence Address: Pedersen & Company, PLLC, P.O. Box 2666, Boise, ID, 83701-2666, US

(21) Appl. No.: 09/770,106

(22) Filed: Jan. 23, 2001

Related U.S. Application Data
(63) Continuation-in-part of application No. 09/261,942, filed on Mar. 3, 1999, now abandoned.

(51) Int. Cl. A01G 9/02

(52) U.S. Cl. 47/86

(57) ABSTRACT

The extant invention is a portable and modular plant growing system comprising at least one plant growing container, each container having a longitudinally elongated vertical enclosure with at least one perforated platform to support a plant growing medium, and at least one opening proximate to the bottom of the container. The enclosures also have holes to permit water drainage and air circulation. A system is provided for conveniently and economically interconnecting the plant growing containers. This interconnecting system comprises modular, snap together commercially available spacers that cooperatively receive and connect together adjacent plant growing containers.

### DESCRIPTION

This application is a continuation in part application of, and claims priority from, co-pending U.S. patent application Ser. No. 09/261,942, filed on Mar. 3, 1999, entitled “Portable Modular Garden” the disclosure of which is incorporated herein by this reference.

### BACKGROUND OF THE INVENTION

1. Field of the Invention

The present invention generally relates to horticulture. More specifically, the present invention relates to modular and portable plant husbandry systems for the storage, transportation, growth, care and propagation of plants.

2. Related Art

Gardening is one of our nation's most popular pastimes. One in four Americans say gardening is a hobby of interest to them. Statistics show interest increases with age from 13% of 18-29 year olds, to 26% of 30-44 year olds, and to 30% of 45-59 year olds. Americans aged 60 and older show the highest interest of all at 33%.

Retail sales for container gardening increased from $387 million in 1996 to $558 million in 1997, for about a 44% increase. Container gardening was most popular with households having people 30-49 years of age (14%), people with a college education (15%), professional people (18%), business people (17%), and married people with children (15%). Twenty-two percent of households with annual incomes of $100,000 and over participated in container gardening. (Source: National Gardening Survey, 1997-1998.)

These data are reflected by the many and diverse containers for the growth and propagation of plants that are shown in the prior art. Known relevant examples are described in the following.

Lashlee (U.S. Design Pat. 396,201) depicts a cylindrical hanging plant container with a plurality of side openings and end caps. Presumably this design supports multiple plants from a single container.

Rakestraw (U.S. Pat. No. 4,250,666) discloses a supporting structure having a plurality of trays for holding plants and soil in an arrangement of decorative or garden plants, along with a lighting means for their illumination.

Weddle (U.S. Pat. No. 4,302,024) discloses a cart for the convenient transportation by one person of floral baskets, pots, sprays, wreaths and the like.

Enrich (U.S. Pat. No. 4,404,767) describes a plant growing apparatus having a tube with openings in its sidewall for the growing plant to pass through. The tube also contains a water reservoir and a wick to supply water to the plants.

Moffett (U.S. Pat. No. 5,031,359) teaches a molded unitary elongated vertical enclosure having a plurality a openings in the side of the enclosure from which plants may grow.

Swearengin et al. (U.S. Pat. No. 5,276,997) discloses a vertical or columnar planter having openings along its sidewalls in which plants are grown. This invention also includes a self-contained water distribution system.

Wente (U.S. Pat. No. 5,381,625) also teaches a vertically disposed upright cylindrical tube having a plurality of keyhole shaped sidewall openings from which plants may grow. Wente also provides an integral watering tube for the selective distribution of water.

Lynch et al. (U.S. Pat. No. 5,533,302) teaches a modular planting system for growing a plurality of plants arranged in a vertical column. This device includes a plurality of planting units that may be stacked together at various relative angular orientations to form a vertical column. Each of the modular planting units includes a center column having a pair of plant containers projecting from both sides of the center column. In addition, a watering system is provided.

As the above presented review of the known relevant prior art discloses, none of the prior art addresses the need for plant growing containers that can be flexibly, compactly, portably and conveniently adapted to support the efficient growing of plants in a variety of decorative and functional configurations. Other deficiencies in the prior art will become apparent in the following discussion that summarizes this invention.

### SUMMARY OF THE INVENTION

The extant invention, a plant growing system, relates to a plurality of plant growing containers, wherein each container comprises a unitary longitudinally elongated enclosure having an open top portion, an open base portion, and a wall extending between the top and base portions. The enclosure internally includes at least one perforate platform to support a plant growing medium, and mechanism/system for allowing the passage of air into and out from the enclosure. A mechanism/system for affixing the support platform(s) to the enclosure's wall is also provided. Each container has a preferably generally cylindrical configuration and is upwardly and vertically disposed, resting on its generally flat base portion. Importantly, a mechanism/system is also provided for interconnecting the containers and thus stabilizing and modularizing the plant growing container system.

Each container of the plant growing system of this invention has at least one opening proximate to the base portion of the enclosure whereby irrigation water may drain from the growing medium and air is circulated through the growing medium. The support platform is also perforated to facilitate water drainage and air circulation.

Preferably, the mechanism/system for interconnecting the plant growing containers comprises modular, snap together spacers adapted to cooperatively receive and connect together adjacent, vertically disposed cylindrical containers. These spacers are commercially available for applications other than plant growing and as such are convenient, economical and imminently practical.

It is a principal object of this invention to provide a plant growing system comprised of at least one plant growing container that may be inexpensively and conveniently connected to other similar or identical containers. By so doing, the garden designer can arrange a grouping of these like containers into any aesthetically pleasing or functionally practical horizontal geometric arrangement of the vertically disposed containers.

Another object of this invention is to provide a plant growing system that is readily portable. The modular design of this invention allows the designer and gardener to easily move individual containers or modular groups of containers to alternate locations. The modular containers may be easily relocated to achieve the desired exposure to light conditions.

It is another object of this invention to allow, by its modular design, the garden designer to easily mix differing species and variety of plants and differing sizes in the same modular grouping. Yet another object provided by the modular garden design is the ability to plant individual or multiple plants in a single container. In such a garden arrangement, the plant caretaker may apply differing watering and fertilizing schemes to meet the specialized needs of the plants in their separate containers. By using this invention, seeds may germinate in their individual containers and need not be transplanted. They may grow to maturity in the same container they were originally planted in.

Another object of this invention is to provide a planting arrangement that can be readily and easily modified during the plant growing process. The modular design of this invention conveniently allows the gardener to rearrange the original container configuration, to reduce the number of containers as the plants grow and occupy more space, or to expand the arrangement to meet any changing needs that may occur.

Another object of this invention is simplicity and versatility. This invention allows the gardener to grow a garden anywhere, requiring no digging and minimal weeding. This plant growing system allows the gardener to place the modularized plant containers at easily accessible locations and at an elevated height thus eliminating the need to kneel or bend over to care for the plants. This feature is a significant benefit to the elderly, disabled and those using wheelchairs.

Yet another very important object of this invention is to reduce the growth of unwanted plants, i.e. “weeds”. The enclosure of the primary containers restricts the incidental introduction of unwanted seeds from wind conditions, bird droppings and the like.

Still another important object of this invention is the near elimination of live pests such as dogs, cats and even insects that exist in the ground. The configuration of the individual containers substantially deters dogs and cats from disturbing the plants. Even plant eating animals such as rabbits are less likely to feed on the plants. The fact that the plants are planted in a growing medium that is provided by the gardener and not planted in the ground reduces infestation by ground insects.

It is another object of this invention to provide a plant growing system that is useful and economical for all plant growing applications. Such non-limiting applications include gardening for pleasure, commercial nurseries and farming.

It is a final object of this invention to provide a portable and modular plant growing system that is durable, non-toxic, environmentally sound and compatible, easily cleaned and compactly stored when not in use.

These and many other features and attendant advantages of the invention will become apparent, as the invention becomes better understood by reference to the following detailed descriptions and accompanying drawings.

### BRIEF DESCRIPTION OF THE DRAWINGS

FIG. 1 shows a side view of a single container of this invention. FIG. 1B shows a top view thereof.

FIG. 2 is a perspective, partial, cutaway view of the container from FIG. 1 showing the mounting of a soil support platform within the container.

FIGS. 3A-3C show top views of the commercially available means for interconnecting adjacent containers according to the present invention.

FIG. 4 is a top perspective view of the plant growing system according to the present invention showing a plurality of plant growing containers interconnected to form plant growing system modules.

FIG. 5 is a side view of several adjacent modules of containers interconnected with the means depicted in FIGS. 3A-3C.

FIG. 6 is a top view of several adjacent containers interconnected with the means depicted in FIG. 3A-3C.

FIG. 7 is a side view of the embodiment depicted in FIG. 5, but with a net basket installed within a container, instead of a soil screen.

FIG. 8 is a side view of another embodiment of the invention for interconnecting adjacent containers.

### DESCRIPTION OF THE PREFERRED EMBODIMENTS

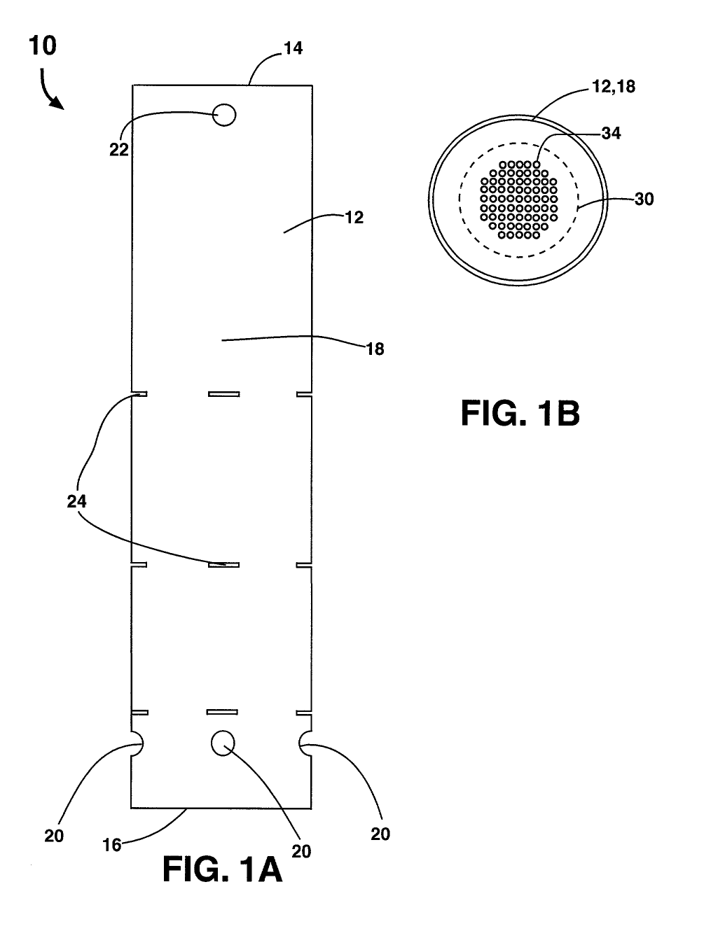

FIG. 1A is an elevation view of container 10 of the portable modular plant growing system of this invention. Container 10 comprises unitary longitudinally elongated enclosure 12 having open top portion 14, an open base portion 16 and wall 18 extending between the top portion 14 and base portion 16. Wall 18 also has an opening, or preferably a plurality of holes 20 proximate to base portion 16 from which irrigation water may drain from the growing medium (not shown) and through which air may circulate. In the preferred embodiment, four such holes (20) are provided at 90 degree positions around the circumference of wall 18. In addition, wall 18 has at least one lifting or irrigation hole 22 proximate to top portion 14. In the preferred embodiment, two diametrically opposed lifting or irrigation holes 22 are provided suitable for grasping by the fingers of the user, or for receiving irrigation equipment. FIG. 1B is a plan view of container 10 showing soil support platform 30 with perforations 34. Finally, FIG. 1A shows the upward, vertical disposition of container 10 and the flat configuration of base portion 16 whereby the upward disposition of container 10 is maintained by being supported by base 16.

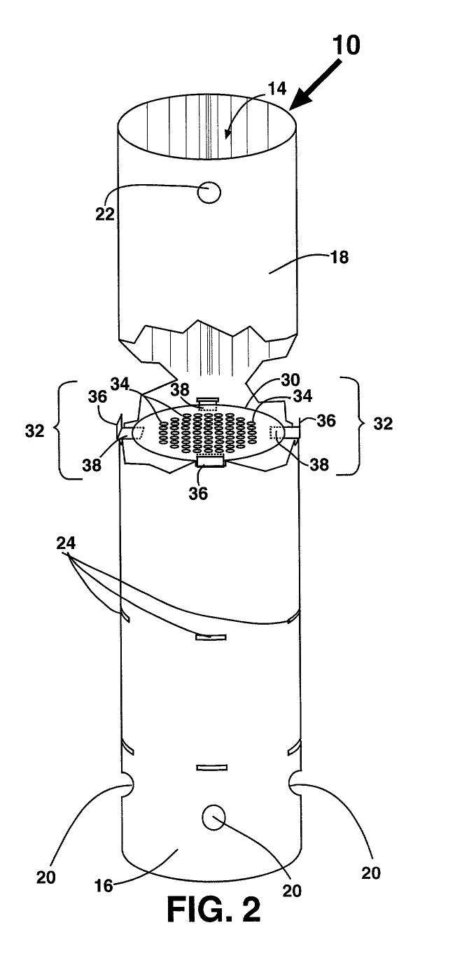

FIG. 2, a cutaway view of container 10, clearly depicts the generally cylindrical configuration of the preferred embodiment. This figure also shows soil support platform 30 that supports a plant growing medium (not shown). Support platform 30 has at least one perforation 34 to facilitate drainage of irrigation water and circulation of air through the growing medium. At least one support platform 30 must be included in the fabrication of container 10.

FIG. 2 also shows support bracket 32 connected through apertures 24 for supporting support platform 30 to wall 18. A number of apertures 24 are provided at various elevations along enclosure 12 to accommodate various growing medium depths in container 10 as selected by the user. As shown in FIG. 2, the preferred embodiment of support bracket 32 is an L-shaped bracket 36 forming ledge 38 upon which platform 30 rests within container 10. Other support members for supporting support platform 30 are acceptable. Examples include hooks, dowels, inserts, ledges bonded to or formed on the interior of wall 18, and even bonding platform 30 directly to wall 18. In the latter case, however, permanently bonding platform 30 to wall 18 will complicate cleaning the container.

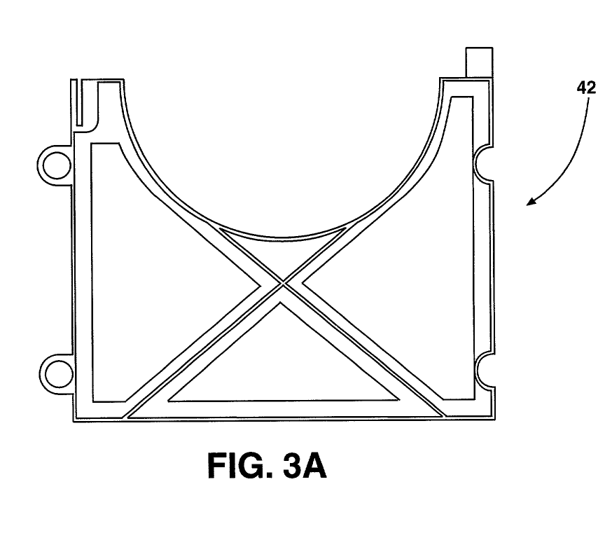

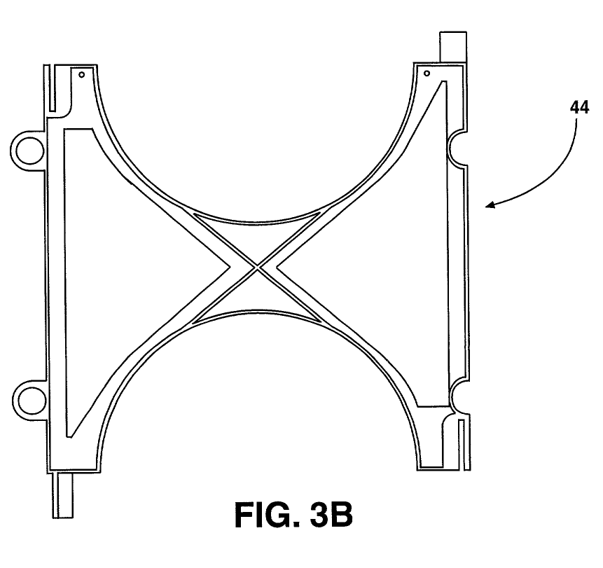

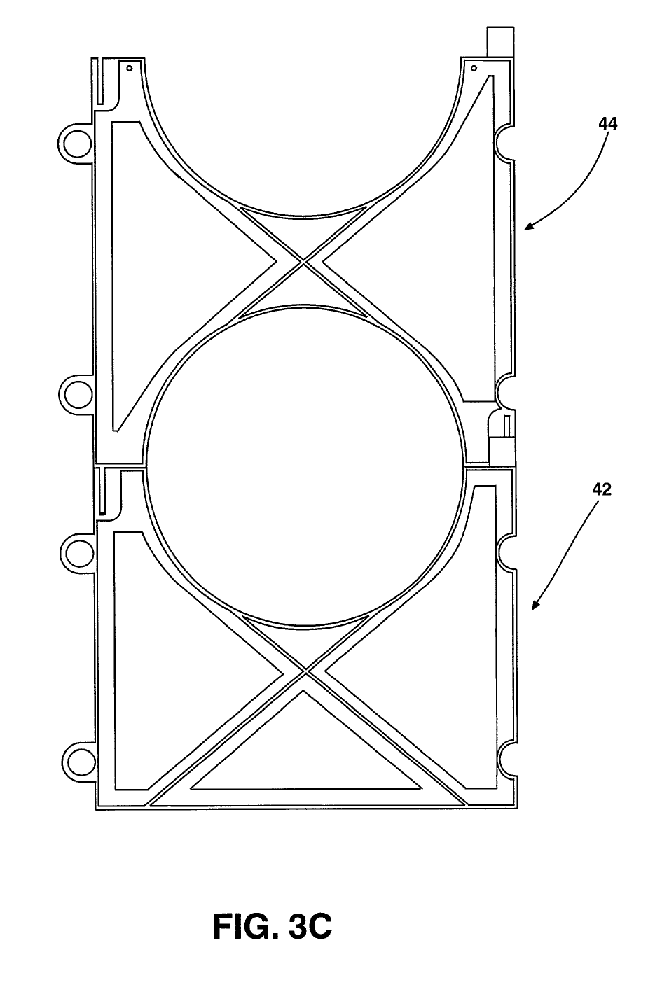

FIGS. 3A-C show commercially available spacers normally used to position and hold ducting and piping. In this invention, these commercial spacers are used to interconnect containers 10 (not shown in this set of figures). FIG. 3A shows an edge spacer 42 that is to be used at the edge of a module, whereas the central spacer 44 shown in FIG. 3B, is used to connected adjacent containers. FIG. 3C shows these spacers connected together. These interconnecting spacers simply snap together, no separate fastener is required.

Spacers 42 and 44 are commercially available for a very wide range of container 10 dimensions. In the case of one manufacturer, spacers are available to accommodate containers as small as 2.5 inches in outside diameter to as large as 6.75 inches in outside diameter. This provides substantial flexibility to the garden system designer.

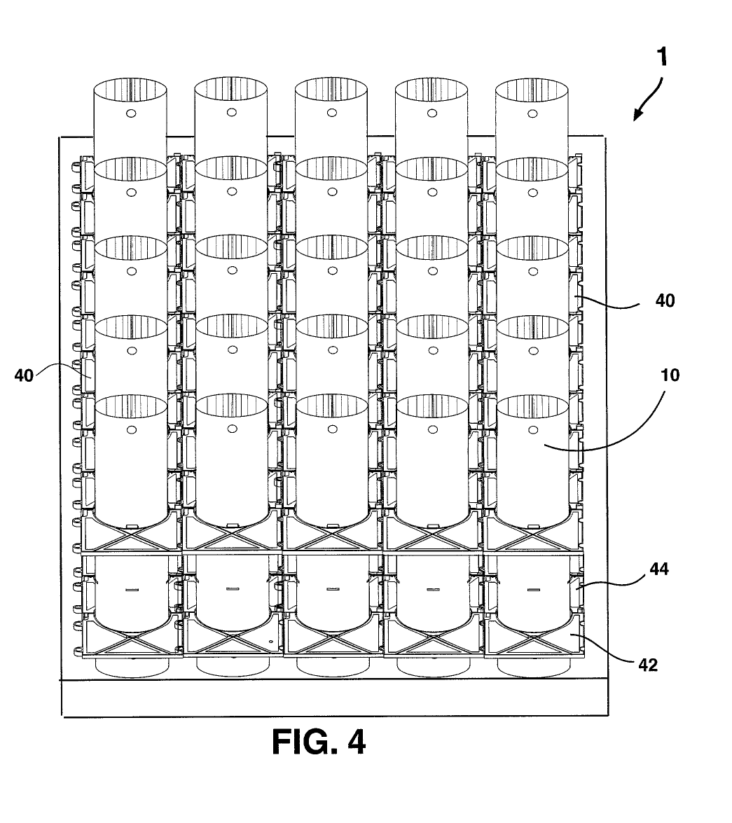

The complete portable modular plant growing system 1, comprising interconnecting means or mechanism 40 and containers 10, is shown in FIG. 4. This figure also shows edge spacers 42 and central spacers 44. Two layers of interconnecting means or mechanism are depicted in the Figure.

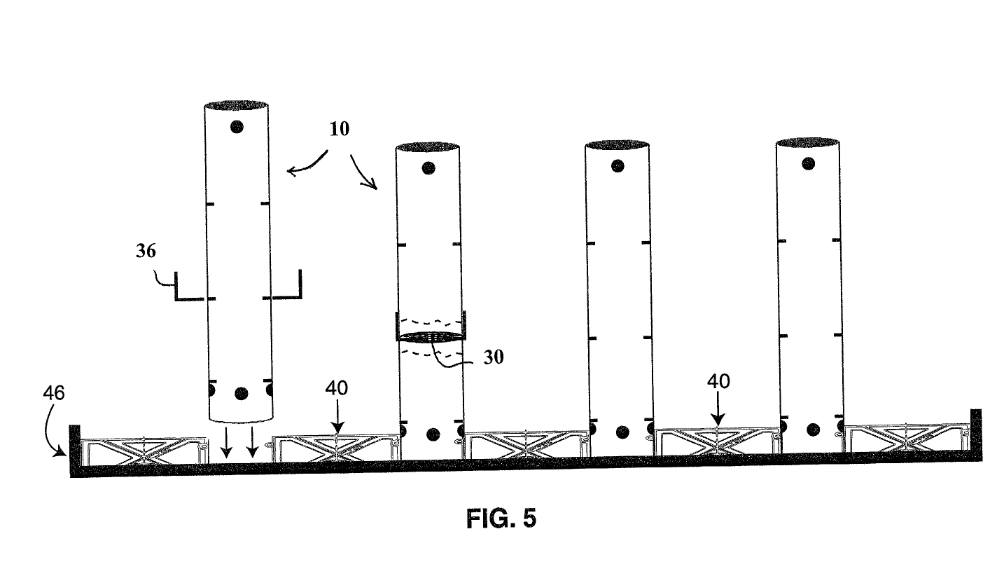

FIG. 5 shows a side view of several adjacent containers according to the present invention interconnecting with one layer of the interconnecting mechanism/means 40. In addition, the several interconnected containers may be placed within a base 46, for example, in order to catch and collect water draining from the containers.

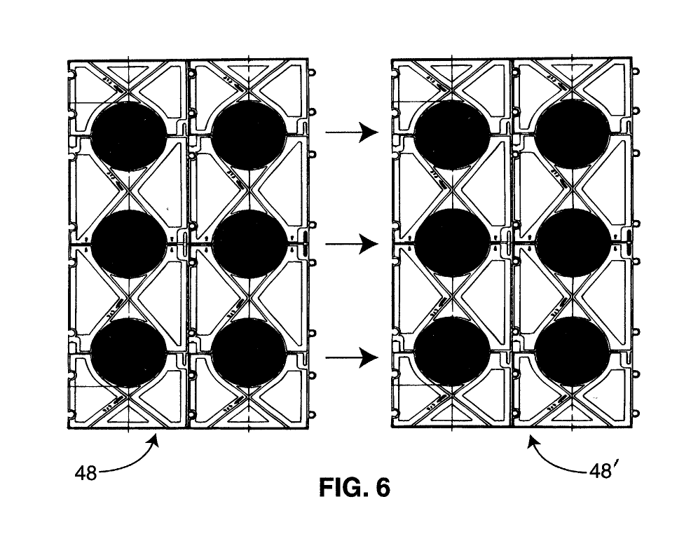

FIG. 6 shows a top view of two sets of adjacent, interconnected containers, each forming a modular group 48, 48′. According to the invention, these modular groups may be joined together to create other, larger modules, or vice-versa.

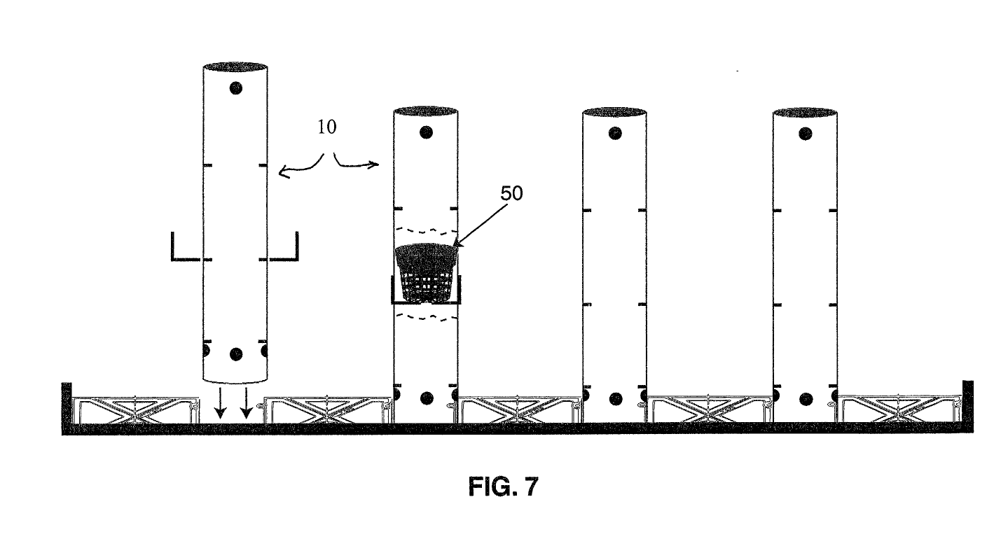

FIG. 7 is a side view of the embodiment of the present invention depicted in FIG. 5, but with a net basket 50 installed within a container, instead of a soil screen (soil support platform 30). Net basket 50 may be supported by L-brackets (support bracket 32) as in the above discussion, or it may be supported within the container by friction fit, dowels, inserts, or by hanging or being hung over open top portion 14.

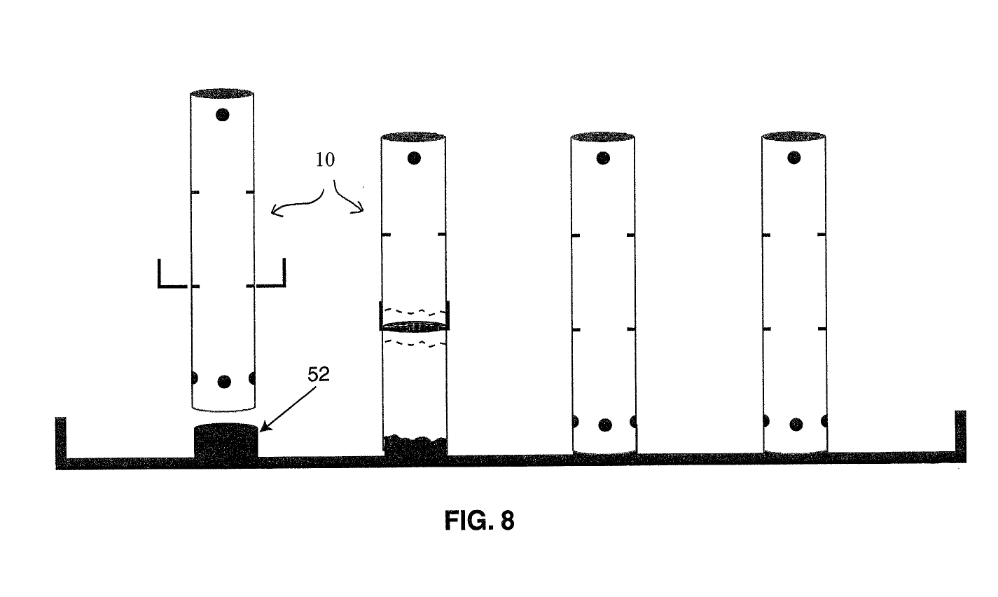

FIG. 8 is a side view of another embodiment of the invention for interconnecting adjacent containers 10. In this embodiment, containers 10 are slipped over cooperating base stands 52 which fit snugly inside or outside open base 16. This way, containers 10 are supported and secured in the upright position. In this embodiment, it is important that base stands 52 not interfere completely with the air vents (holes 20).

Synthetic plastic, for example, polyvinylchloride, commonly referred to as PVC, is the preferred material for forming enclosure 12 of the plant growing system 1 of this invention. PVC provides the desired rigidity, durability and non-corroding features of this invention. Other plastics are acceptable as well as metals such as aluminum and stainless steel. In fact the preferred material for support brackets 32 and other support members is stainless steel, however PVC is acceptable. Also, soil support platform 30 is preferably also formed from stainless steel but PVC is also acceptable.

The size of this invention is only limited by the needs of the user and the availability of materials in the desired sizes. Common Schedule 40 PVC pipe is the preferred source for the containers. It is available in sizes down to ½ inch and up to several inches in diameter. The lengths of the containers are similarly selected by the user.

In the preferred embodiment, the enclosures 12 are formed from 6 inch diameter, 30 inch long Schedule 40 PVC pipe sections. A first set of apertures 24 (used to position support platform 30) are placed 8 inches from the top of the container and a second set is placed 8 inches below the first set (and thus 14 inches from the bottom of the container). Other locations are acceptable depending on the needs of the plants and the preferences of the gardener. In the preferred embodiment described, apertures 24 are rectangular having dimensions of ⅛ inch by ½ inch. Apertures 24 may be any conventional shape or size, adapted to cooperate with the support member chosen and wall 18. For example, aperture 24 may be a round hole to receive a PVC dowel, peg or plug which extends into the interior of container 10 to support platform 30.

Soil support platform 30, see FIG. 1B is generally a thin circular disk having an external diameter approximately ⅛ inch less than the inside diameter of the selected enclosure 12. Support platform 30 has at least one perforation 34 having a diameter of ¼ inch. However, other diameters, size and shapes of perforation 34 are acceptable.

The preferred L-shaped brackets are approximately 2 inches long, ½ inch wide and ⅛ inch thick. They are bent into a 90 degree angle at the approximate mid point of their longest dimension. Drainage and air circulation holes 20 and lifting holes 22 are each about 0.75 inches in diameter. Their locations near the ends of the container are not critical. In the preferred embodiment, four drainage and air circulation holes are provided spaced equidistant around the periphery of enclosure 12 about 2 inches from the open end of base portion 16. Again, holes 20 may be any conventional shape or size, adapted to provide air exchange capacity. For example, holes 20 may be vertical slots extending up from base portion 16.

The assembly of plant growing system 1 is as follows. Drainage and air circulation holes 20, lifting holes 22 and perforations 34 are formed in wall 18 by drilling and/or cutting. Support brackets 32 are then placed in the desired apertures 34 along the length of wall 18 and soil support platform 30 is positioned on ledge 38 of brackets 36. The desired number and arrangement of containers 10 are then interconnected by edge and central spacers 42 and 44. Edge spacers are used where a container 10 is on the perimeter of the arrangement; central spacers 44 are used elsewhere.

In an alternative embodiment, a framework (not shown) may be erected above the plant growing system to support an irrigation system comprised of known methods, components and materials. Examples include water emitters and associated piping, pressure regulators, valves, programmers, connecting fittings and so forth. Such irrigation systems may include fertilizer, insecticides, and other compounds necessary for the care of the plants.

In yet another embodiment, a framework may be erected to physically support the growing plants, such as conventional trellises provide. This plant growing framework may be integrated with the above described irrigation framework.

In a fashion similar to the above irrigation and support frameworks, an artificial lighting framework may be provided. Again, this framework may be integrated with either or both of the irrigation or support frameworks.

Although this invention has been described above with reference to particular means, materials and embodiments, it is to be understood that the invention is not limited to these disclosed particulars, but extends instead to all equivalents within the scope of the following claims.

We claim:

1. A plant growing container comprising,
a unitary longitudinally elongated enclosure having an open top portion, an open base portion and a wall extending between the top and base portions,
a least one perforate support platform within said enclosure whereby a plant growing medium is supported,
a means for supporting said support platform within said enclosure, and
wherein the wall of said enclosure has a hole proximate to the base portion whereby irrigation water may drain from, and air may circulate through, the growing medium.

2. A plant growing container according to claim 1 wherein said enclosure has a generally cylindrical configuration, said enclosure further being upwardly disposed, and wherein said base portion is flat whereby the upward disposition of said enclosure is maintained by said base portion.

3. A plant growing container according to claim 1 wherein the wall of said enclosure has a plurality of apertures for receiving said means for supporting said platform.

4. A plant growing container according to claim 1 wherein the wall of said enclosure has at least one lifting hole proximate to the top portion.

5. A plant growing system comprising,
a plurality of plant growing containers, each container including:
a unitary longitudinally elongated enclosure having an open top portion, an open base portion, and a wall extending between the top and base portions,
at least one perforate support platform within said enclosure whereby a plant growing medium is supported, and
a means for supporting said support platform within said enclosure, and
a means for interconnecting said plurality of plant growing containers,
wherein the wall of said enclosure has a hole proximate to the base portion whereby irrigation water may drain from, and air may circulate through, the growing medium.

6. A plant growing system according to claim 5 wherein said enclosure has a generally cylindrical configuration, said enclosure further being upwardly disposed, and wherein said base portion is flat whereby the upward disposition of the enclosure is maintained by said base portion.

7. A plant growing system according to claim 5 wherein the wall of said enclosure has a plurality of apertures for receiving the means for supporting said platform.

8. A plant growing system according to claim 5 wherein the wall of the enclosure has at least one lifting hole proximate to the top portion.

9. A plant growing system according to claim 5 wherein the means for interconnecting the plurality of plant growing containers comprises modular, snap together spacers adapted to cooperatively receive and connect together adjacently disposed containers.

10. A plant growing system according to claim 5 further comprising an irrigation system.

11. A plant growing system according to claim 5 further comprising an plant growing physical support system.

12. A plant growing system according to claim 5 further comprising an artificial lighting system.
